(19) United States
(12) Patent Application Publication
(10) Pub. No.: US 2014/0167662 A1
(43) Pub. Date: Jun. 19, 2014

(54) Inverter Device

(71) Applicants: Toshiyuki Ajima, Tokyo (JP); Hiroyuki Yamada, Hitachinaka (JP); Hiroshi Tamura, Tokyo (JP); Kimihisa Furukawa, Tokyo (JP)

(72) Inventors: Toshiyuki Ajima, Tokyo (JP); Hiroyuki Yamada, Hitachinaka (JP); Hiroshi Tamura, Tokyo (JP); Kimihisa Furukawa, Tokyo (JP)

(73) Assignee: Hitachi Automotive Systems, Ltd., Ibaraki (JP)

(21) Appl. No.: 14/234,455

(22) PCT Filed: Jul. 25, 2012
(86) PCT No.: PCT/JP2012/068849

§ 371 Date: Jan. 23, 2014

(30) Foreign Application Priority Data
Jul. 26, 2011 (JP) 2011-162765

(51) Int. Cl. H02P 6/16

(52) U.S. Cl. CPC H02P 6/16
USPC 318/400.04

(57) ABSTRACT

An inverter device that controls a motor using a signal from a position sensor for detecting a rotor rotational position of the motor includes an initial adjustment unit that outputs a phase of current for designating a motor rotational position by rotating the motor in a clockwise direction of the motor and a phase of current for designating the motor rotational position by rotating the motor in a counter-clockwise direction of the motor.

### TECHNICAL FIELD

The present invention relates to an inverter device that outputs an applied voltage for sensing a position error between a rotor detection position calculated from a rotational position sensor signal of a motor and a position of an electromotive force.

### BACKGROUND ART

In a motor equipment using a synchronous motor, for appropriate control of phase of an electromotive force and an applied voltage, motor driving by detecting a rotor detection position from a rotational position sensor signal of the motor and appropriately controlling phase of the applied voltage is desired. In PTL 1, a technology of sensing and correcting a position error between the rotor detection position obtained from the rotational position sensor signal of the motor and a position of the electromotive force is disclosed.

### CITATION LIST

### Patent Literature

PTL 1: JP-A-2003-319680

### SUMMARY OF INVENTION

### Technical Problems

In PTL 1, in an apparatus that performs motor control using a position Os obtained from an input signal from the rotational position sensor of the motor, for sensing a rotor detection position error θe from the position of the electromotive force, a method of supplying motor lock currents Iu, Iv, Iw for an ideal position θ*, pulling the rotor to the motor rotational position coincident with the position of the electromotive force (the motion that a motor rotor rotates and the rotor locks rotation by a magnetomotive force formed by motor winding according to the motor lock currents and a magnetic attractive force between the rotor magnet and the motor), sensing a phase difference between the rotor detection position θs and the ideal position θ* as the rotor detection position error θe, correcting the rotor detection position error θe at motor driving, and outputting an applied voltage is disclosed.

However, when the rotor is pulled to the motor rotational position as the ideal position θ*, an output torque becomes smaller as a phase difference between an actual motor rotational position θm and the ideal position θ* is smaller. Specifically, when the position θm coincides with the ideal position θ*, the output torque becomes zero.

As shown in FIG. 3, in an actual motor, there are friction torque and Gagging torque of the output shaft, and the position θm does not coincide with the ideal position θ* and position deviation θr is generated. The position deviation θr is a detection accuracy of the rotor detection position error θe as it is, and the position deviation θr is required to be made smaller and the motor lock currents are increased.

However, it is necessary to minimize the magnitudes of the motor lock currents due to the relationship of loss and heat generation of an inverter circuit, and there is a problem that the settling time of the motor rotational position is longer as the motor lock currents are increased. Therefore, in the motor equipment in which the friction torque and the togging torque change depending on the stop position of the motor, it has been impossible to accurately sense the rotor detection position error θe.

The invention is to provide an inverter device that senses and controls a rotor detection position error θe between a position θs obtained from an input signal from a rotational position sensor of a motor and a position of an electromotive force with high accuracy.

### Solution to Problems

In order to solve the problems, for example, the apparatus may be adapted to have an initial adjustment unit that outputs a phase of current for designating a motor rotational position by rotating the motor in a clockwise direction of the motor and a phase of current for designating the motor rotational position by rotating the motor in a counter-clockwise direction of the motor. Thereby, the friction torque at clockwise rotation and the friction torque at counter-clockwise rotation may be cancelled.

Further, the initial adjustment unit may be adapted to output the phase of current for rotating the motor in the clockwise direction, and then, output the phase of current for rotating the motor in the counter-clockwise direction. Thereby, the influence of the cogging torque in the motor rotational position may be cancelled even when the initial stop position of the motor is taken in the clockwise direction.

Furthermore, the initial adjustment unit may be adapted to output the phase of current for rotating the motor in the counter-clockwise direction, and then, output the phase of current for rotating the motor in the clockwise direction. Thereby, the influence of the cogging torque in the motor rotational position may be cancelled even when the initial stop position of the motor is taken in the counter-clockwise direction.

Moreover, the initial adjustment unit may set a rotation angle for rotating the motor to 60 degrees in electric angle. Thereby, there is an advantage that the motor positioning operation becomes stable because an applied voltage according to a voltage vector of the inverter may be output.

In addition, the initial adjustment unit may set a vehicle in a parking state with a neutral gear at inspection of the inverter device and output a command signal for initial operation. Thereby, there is an advantage that the motor positioning operation becomes stable because a load on the motor is minimized and the applied voltage according to the voltage vector of the inverter may be output in a state where the motor has been incorporated in the vehicle.

Further, the apparatus may be adapted to include a control unit that increases a PWM duty so that an inverter DC current in a stop position of the rotor may take a predetermined current value and then holds the PWM duty, and outputs the PWM duty so that the applied voltage may take a predetermined value. Thereby, the magnitude of the current when the motor rotational position is designated by rotating the motor in the clockwise or the counter-clockwise direction may be adjusted and the adjustment time may be shortened.

Furthermore, the apparatus may be adapted to include a control unit that increases the PWM duty so that the inverter DC current may take a predetermined current value at the phase of current for designating the motor rotational position by rotating the motor in the clockwise direction and performs output with the PWM duty held and increases the PWM duty so that the inverter DC current may take a predetermined current value at the phase of current for designating the motor rotational position by rotating the motor in the counter-clockwise direction and performs output with the PWM duty held.

Thereby, there is an advantage that the magnitude of the current when the motor rotational position is designated may be constantly appropriately adjusted by rotating the motor in the clockwise or the counter-clockwise direction.

### Advantageous Effects of the Invention

According to the motor and the inverter device of the invention, in the detection of the rotor position detection error θe between the position θs obtained from the input signal from the rotational position sensor of the motor and the position of the electromotive force, the phase of current for pulling the motor rotational position by rotating the motor in the clockwise direction of the motor and the phase of current for pulling the motor rotational position by rotating the motor in the counter-clockwise direction of the motor are output, and thereby, the magnitudes of the friction torque and the cogging torque of the motor may be cancelled and the rotor position detection error θe may be sensed with high accuracy.

### BRIEF DESCRIPTION OF DRAWINGS

FIG. 1 is a block diagram showing a configuration of a motor equipment of the invention.

FIG. 2 shows configuration diagrams of a motor in a first embodiment.

FIG. 3 shows sectional views showing a sensor attachment error in the first embodiment.

FIG. 4 is a characteristic diagram showing motor lock currents and motor rotational positions in the first embodiment.

FIG. 5 is a flowchart showing an initial position adjustment operation in the first embodiment.

FIG. 6 is a vector diagram showing the initial position adjustment operation in the first embodiment.

FIG. 7 is a waveform diagram showing the initial position adjustment operation in the first embodiment.

FIG. 8 shows sectional views showing rotational positions showing the initial position adjustment operation in the first embodiment.

FIG. 9 is a configuration diagram of an electric power steering system to which the motor equipment of the invention is applied.

FIG. 10 is a configuration diagram of a hybrid automobile system to which the motor equipment of the invention is applied.

### DESCRIPTION OF EMBODIMENTS

As below, a first embodiment of the invention will be explained using the drawings.

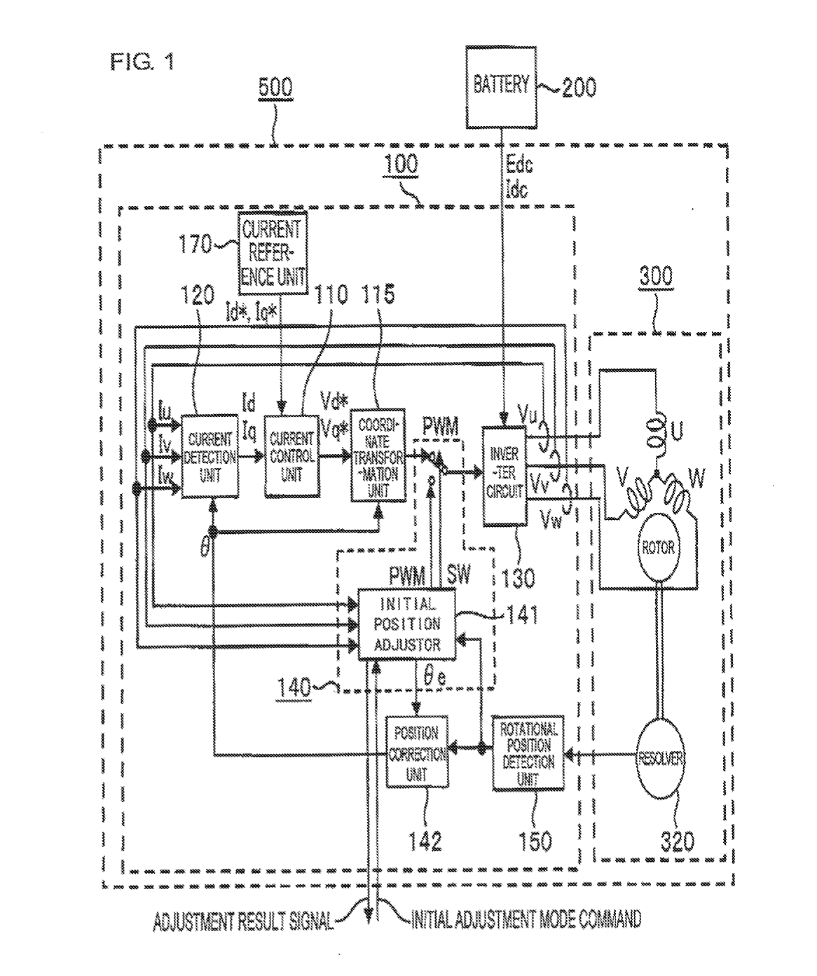

FIG. 1 is a block diagram showing a configuration of a motor driving apparatus having an inverter device of the invention.

Motor equipment 500 is suitable for application of driving a motor with high efficiency by detecting an attachment position error of a rotational position sensor of a motor and correcting the error at motor driving. The motor equipment 500 has a motor 300 and a motor driving apparatus 100.

The motor driving apparatus 100 has a current detection unit 120, a current reference unit 170, a current control unit 110, a coordinate transformation unit 115, an inverter circuit 130, a rotational position detection unit 150, an initial position adjustment unit 140, and a position correction unit 142. A battery 200 is a DC voltage source for the motor driving apparatus 100, and a DC voltage Edc of the battery 200 is transformed to three-phase AC with variable voltage and variable frequency by the inverter circuit 130 of the motor driving apparatus 100 and applied to the motor 300.

The motor 300 is a synchronous motor rotationally driven by supply of three-phase AC. A rotational position sensor 320 is attached to the motor 300 for controlling phase of the applied three-phase AC voltage with phase of an electromotive force of the motor 300, and a rotor detection position θs is calculated from an input signal of the rotational position sensor 320 in the rotational position detection unit 150. Here, a resolver including an iron core and winding is suitable for the rotational position sensor, however, there is no problem in the use of a GMR sensor or a sensor using Hall element.

The motor driving apparatus 100 has a current control function for controlling output of the motor 300, and outputs a current detection value (Id,Iq) obtained by dq-transformation from a three-phase motor current value (Iu, Iv, Iw) and a rotational position θ in the current detection unit 120. The current control unit 110 outputs a voltage reference (Vd*,Vq*) so that the current detection value (Id,Iq) may coincide with a current reference value (Id*,Iq*) created in response to target torque in the current reference unit 170.

In the coordinate transformation unit 115, the output voltage is adjusted by once transforming the voltage to the applied three-phase voltage for the motor from the voltage reference (Vd*,Vq*) and the rotational position θ, and then, on/off-controlling semiconductor switch elements of the inverter circuit 130 using a pulse-width modulated (PWM) drive signal.

The initial position adjustment unit 140 detects a rotor detection position error θe as a phase (position) difference between the rotational position detected from a signal of the rotational position sensor attached to the motor and the electromotive force. An initial adjustment actuator 141 receives an initial position adjustment mode command via CAN communications, switches a PWM signal to a signal from the initial adjustment actuator 141, detects the rotor detection position error θe, and outputs it as an adjustment result signal via CAN communications or the like. In the initial position adjustment, the motor current is detected and the current value is controlled. In the position correction unit 142, the rotor detection position θs is corrected using the rotor detection position error θe and the rotational position θ with the corrected attachment position error or the like is output.

Note that, in the motor equipment 500, when the rotational speed of the motor 300 is controlled, a motor rotational speed or is calculated using the temporal change of the rotational position θ and a voltage reference or a current reference is created to follow a speed command from a higher-level controller. Further, when the output torque is controlled, the current reference (Id*,Iq*) is created using a relational expression of the motor current (Id,Iq) and the motor torque or a map thereof.

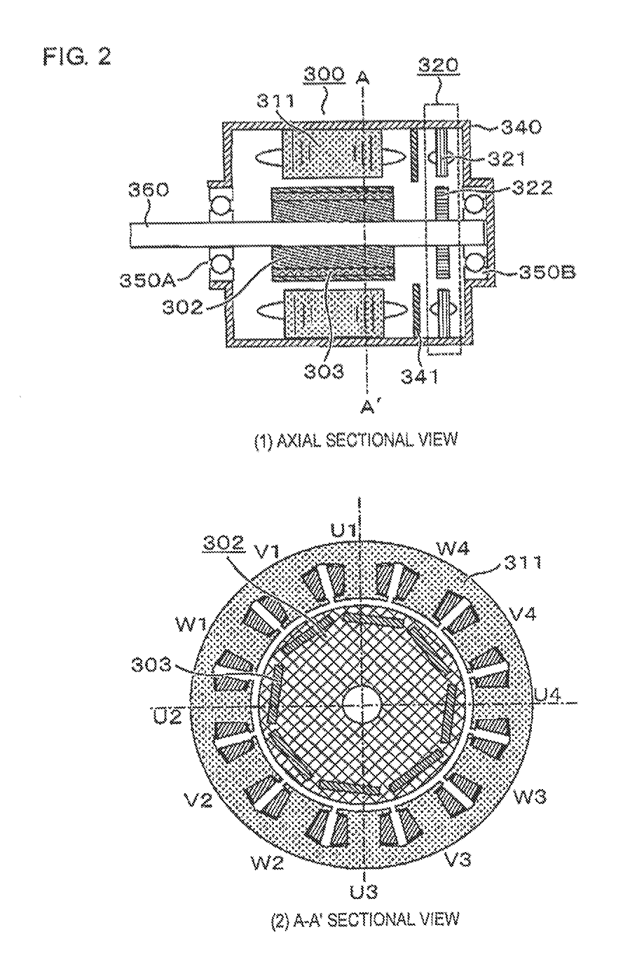

Next, the configuration diagram of the motor in the first embodiment will be explained using FIG. 2.

FIG. 2 shows a section in a motor shaft direction and a radial (A-A′) sectional view of the motor 300. The motor shown in the embodiment is a permanent magnet synchronous motor having a permanent magnet field, and specifically, a buried-magnet type permanent magnet synchronous motor in which a permanent magnet is buried or embedded in a rotor core. In a stator 311, three-phase winding of U, V, W is sequentially wound around the teeth of a stator core. A rotor 302 (including a rotor core, a permanent magnet 303, and a motor shaft 360) is provided with a gap inside of the stator 311 to form an inner rotor motor.

The rotational position sensor 320 is inside a motor housing, a magnetic sealing plate 341 is set between the stator 311 and the rotational position sensor 320, and a sensor stator 321 of the rotational position sensor is fixed to the motor housing. A sensor rotor 322 of the rotational position sensor is connected to a rotor by the motor shaft 360 and the rotor shaft 360 is rotationally supported by bearings 350A, B.

The motor is a concentrated winding motor, however, a distributed-winding motor may be used. Further, the resolver is used for the rotational position sensor 320, however, there is no problem in the use of a Hall element or a GMR sensor because the same detection can be performed using a magnetic excitation signal for a bias voltage of the sensor element.

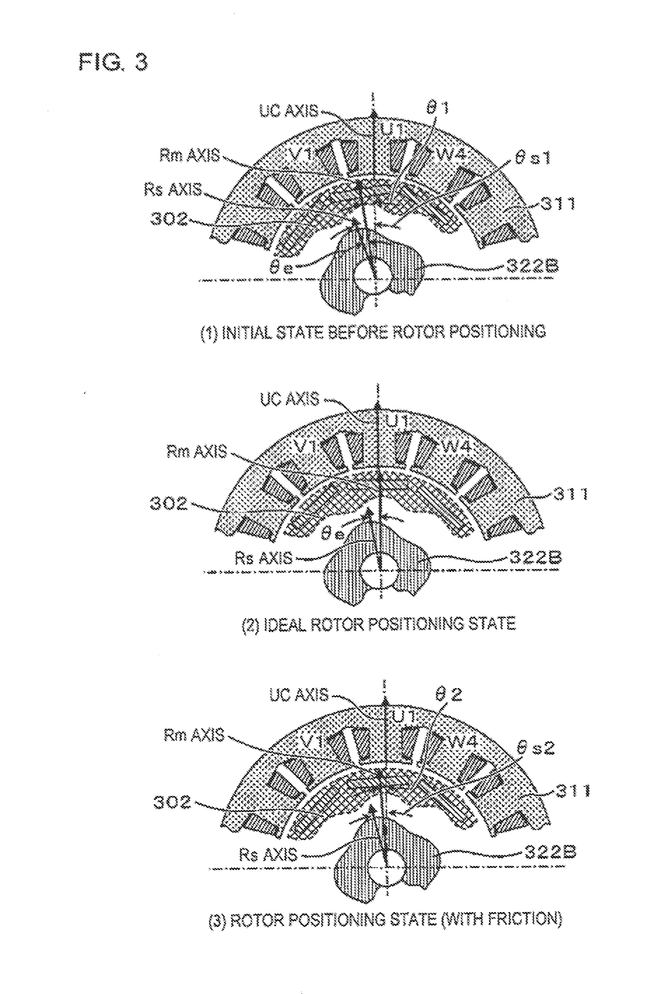

Next, sectional views showing a sensor attachment error in the first embodiment will be explained using FIG. 3. In the drawings, for showing phase of a counter-electromotive force and the attachment position error of the rotational position sensor, the position relationships among the stator and the rotor of the motor, and the rotor of the resolver are schematically shown as radial sectional views of the motor as seen from the resolver rotor side. Here, the consideration of the attachment position error of the resolver stator may be handled as the attachment position error of the resolver rotor for convenience. The resolver has four poles, but may be changed according to the number of pairs of poles of the motor.

FIG. 3(1) shows an initial state before rotor positioning in which the motor is stopped before energization of the inverter. The center axis of the permanent magnet (Rm axis) of the motor rotor 302 as a motor d-axis with respect to the U-phase coil axis (UC axis) of the stator 311 is at a position θ1. The axis of the salient pole (0 degrees) of the sensor rotor 322 is the resolver rotor axis (Rs axis) and a rotor detection position θs1 of the rotational position sensor. The position shift between the Rm axis and the Rs axis is the attachment position error θe and the amount of position shift determined by the mechanical attachment position error, and is regarded as the individual difference with respect to each motor determined after motor assembly.

If it is possible to control the attachment position error within ±1 degree in mechanical angle, in the case of a motor having four pairs of poles, the amount of position shift in electric angle used for motor control is four times, ±4 degrees, and, in the case of a motor having eight pairs of poles, the amount corresponds to ±8 degrees in electric angle. The position error in electric angle is a current control error in motor control such as field-weakening control and leads to increase in motor power consumption, and thus, it is necessary to control the position error in electric angle to be smaller (handle the error as an electric angle for the rotational position of the motor not clearly specified).

Generally, since control in mechanical accuracy is difficult, the position error is measured in advance and held in a nonvolatile memory within the inverter, and the rotational position θ after correction of the rotor detection position θs using the position error measured in advance by the position correction unit 142 is used for application to the motor control.

A function of incorporation of this logic of measuring the position error in advance into the inverter for automatic adjustment is desired. For example, a method of applying a lock current to the motor, pulling the motor rotational position for positioning, and using deviation of the phase of current (the phase of the applied current) from the rotor detection position θs as the rotor detection position error θe is known.

Here, not only friction torque is generated on the output shaft of the motor but also torque fluctuation (cogging torque or the like) is generated due to the magnetic flux distribution determined by the structure of the motor stator 311 and the magnet 303 of the rotor 302.

FIG. 3(2) shows an ideal state without friction torque or cogging torque in which the rotor detection position error θe obtained by the deviation of the phase of current from the rotor detection position θs is equal to the attachment position error.

However, actually, friction torque and cogging torque have influence and, as shown in FIG. 3(3), the Rm axis of the actual equipment is not aligned with the UC axis of the phase of current and has an amount of position shift θ2, and the detection accuracy of the rotor detection position error is deteriorated.

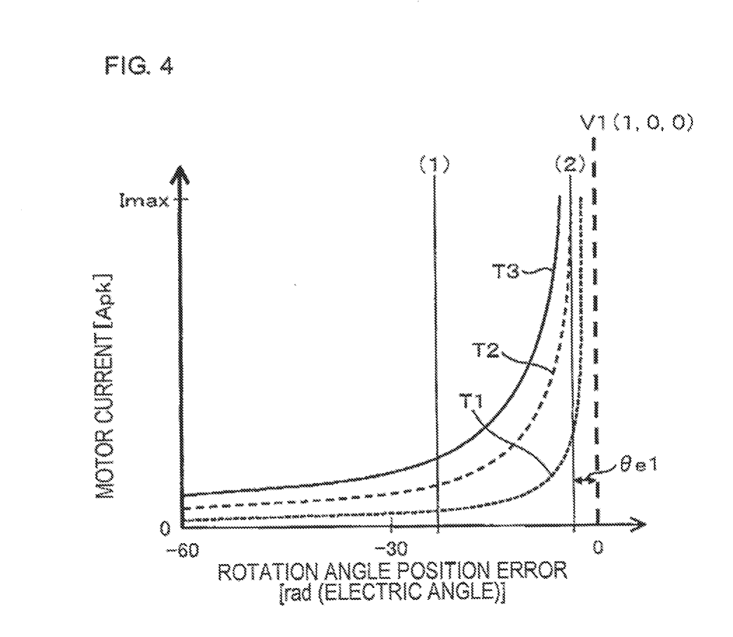

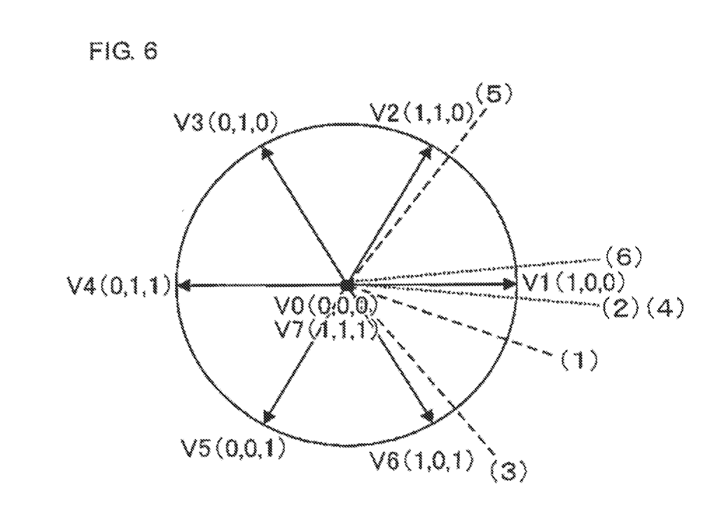

Next, a characteristic diagram showing the motor lock current and the motor rotational position in the first embodiment will be explained using FIG. 4. The position of the UC axis in FIG. 3 is at 0 degrees of the rotation angle position error of the horizontal axis in FIG. 4, and a position of a V1 vector in FIG. 6 to be described later. When the motor stops in the position (1) in FIG. 4, the motor lock current flows by energization of the V1 vector, the motor rotational position moves, and the rotation angle position error becomes smaller. On the other hand, the motor torque is expressed by (Eq. 1).

T=Pn·{φ·Iq+(Ld−Lq)·Id·Iq} (Eq. 1)

Where T: torque, Pn: number of pairs of poles, φ: flux content of motor, Ld: d-axis inductance, Lq: q-axis inductance, Id: d-axis current, and Iq: q-axis current, and, suppose that the phase angle of the q-axis and the current I is β, T is expressed by (Eq. 2).

T=Pn·{φ·I·cos β+½×(Ld−Lq)·I²·sin(2β)} (Eq. 2).

When the motor lock current I is flown and the motor rotational position is pulled, the state of Iq=0 and Id=I is settled and motor torque T=0. Accordingly, the motor rotational position actually stops in the position where the friction torque and the motor torque are balanced. Suppose that the friction torque satisfies T3>T2>T1, the rotation angle position error is larger as the friction torque is larger.

If the motor current is made larger, the rotation angle position error becomes smaller and converges to a specific rotation angle position error. For example, when the friction torque is T2, the rotation angle position error converges to θe1. In the case where the magnitude of the friction torque changes depending on the rotational position of the motor or viscous drag changes depending on the temperature change, it is impossible to sense the position error with high accuracy and minimization of the influence of the friction torque is absolutely necessary.

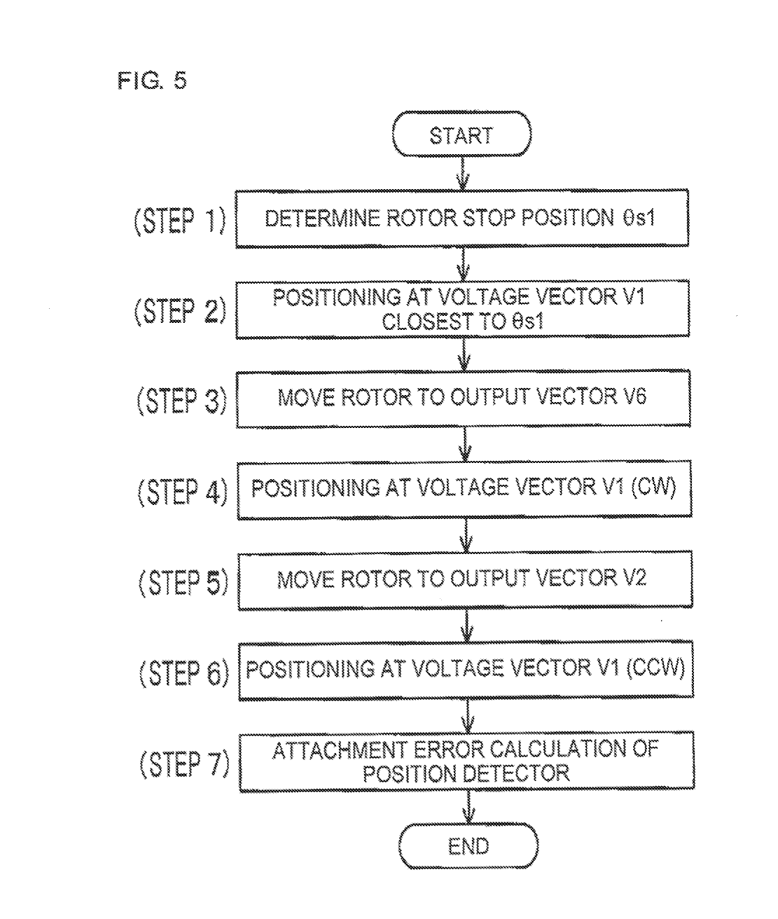

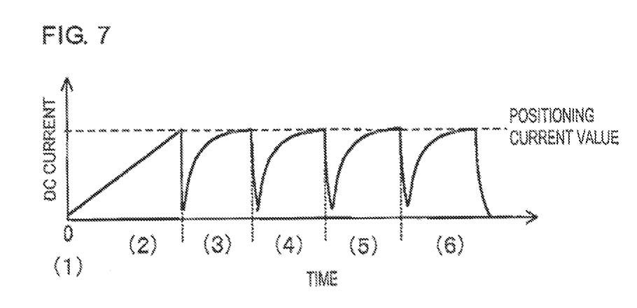

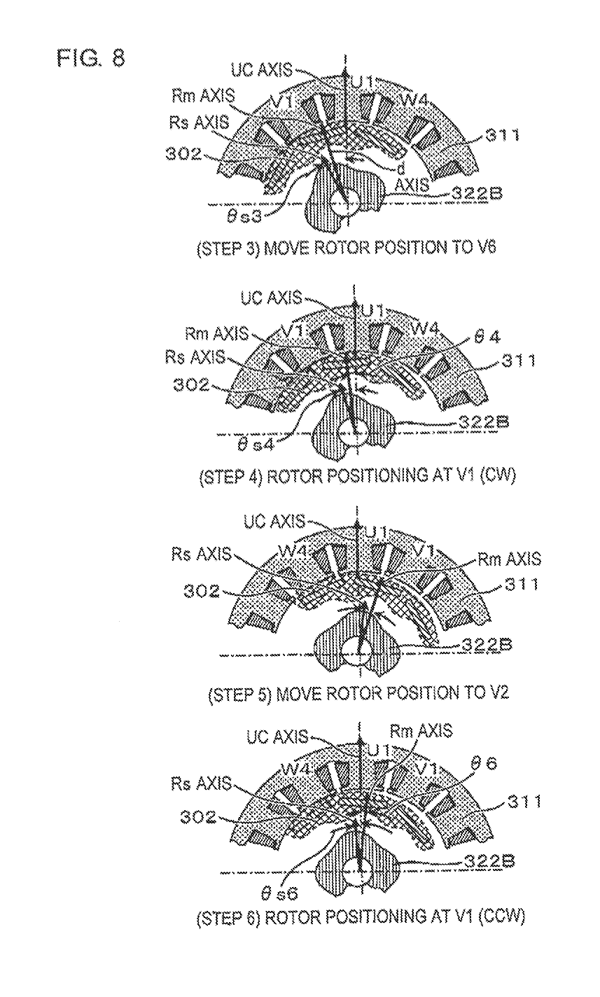

Next, an initial position adjustment operation in the first embodiment will be explained using FIGS. 5 to 8. FIG. 5 is a flowchart showing the initial position adjustment operation in the first embodiment. FIG. 6 is a vector diagram showing the initial position adjustment operation in the first embodiment. FIG. 7 is a waveform diagram showing the initial position adjustment operation in the first embodiment. FIG. 8 shows sectional views showing rotational positions showing the initial position adjustment operation in the first embodiment.

The flowchart of FIG. 5 is executed as a microcomputer program of the controller of the inverter, and energization is performed using the voltage vector of the inverter shown in FIG. 6 as the applied voltage. The DC current Idc of the inverter is shown in FIG. 7 (pulsed current in response to PWM pulse plotted with peak values).

The explanation will be made according to the steps in FIG. 5. Step 1 is a state in which the motor stops before energization, and the rotor detection position θs1 as the rotor stop position corresponding to the position of (1) in FIG. 6 is sensed. At step 2, the voltage vector V1 (1,0,0) closest to the rotor detection position θs1 as the stop position is output, the motor current is increased in a ramp form and PWM pulse width having a preset motor current value is output, and the settling time of the motor position is shortened (the motor current may be changed in a step form). The DC current Idc has a section of (2) in FIG. 7. The motor halts in the position of (2) in FIG. 6. Here, the operations at step 1 and step 2 are for smooth execution of the initial position adjustment operation, and may be omitted.

At step 3, for moving the motor to the position rotated to 60 degrees from the current motor position, the voltage vector V6 (1,0,1) is output and the DC current Idc takes a temporal waveform of the section of (3). The current drops from the section (2) to the section (3) of the DC current Idc due to control of the applied voltage to be constant (PWM constant) when the voltage vector is changed because the motor speed when the voltage vector is switched is higher and the counter-electromotive force is larger. If the constant DC current control is performed, the temporal waveform may be made nearly constant, however, if the number of codes of the motor control software and the operation sound and the settling time at switching of the voltage vector are considered, there is no particular problem without the constant DC current control.

The DC current Idc is the same at the subsequent steps and a current waveform in which five current sections are continuous is obtained by the initial position adjustment operation. At step 4, the voltage vector V1 (1,0,0) is output and the motor is settled on the UC axis as the vector of V1 by CW rotation. The position of the Rm axis at this time is θ4, the rotor detection position is θs4, and θs4=θ4+θe is achieved. Then, for moving the motor to the position rotated to nearly 60 degrees from the motor position at step 5, the voltage vector V2 (1,1,0) is output, and, at step 6, the voltage vector V1 (1,0,0) is output and the motor is settled on the UC axis as the vector of V1 by CCW rotation. The position of the Rm axis at this time is θ6, the rotor detection position is θs6, and θs6−−θ6+θe is achieved.

Here, the motor friction torque in the V1 vector is nearly equal and |θ4 |=|θ6|, and the motor is made closer to the V1 vector by the rotation of CW (clockwise) and CCW (counter-clockwise) and the signs of θ4 and θ6 are reversed (the friction torque acts oppositely).

At step 7, the attachment error calculation of the position detector is performed and the rotor detection position error θe is obtained using θe=(θs4 θs6)/2, and thereby, the influence of the friction torque may be cancelled and the attachment position error of the rotational position sensor may be detected with high accuracy.

Note that, in the case where there is friction torque depending on the rotation direction, the friction torque may be calculated supposing that the current values of step 2 are I2 and I2′ (I2<I2′) based on the characteristics of FIG. 4. For simplification, if Id=Lq is assumed, from (Eq. 2),

T=Pn·φI2·cos β=Pn·φI2·sin(θ1) (Eq. 3)

T=Pn·φI2′·sin(θ2′)=Pn·φI2′·sin(θ1−Δθ) (Eq. 4)

are obtained. Here, Δθ=θ2−θ2′.

By solving the simultaneous equations of (Eq. 3) and (Eq. 4), θ2 and θ2′ may be obtained, the friction torque when changing depending on the rotation direction may be calculated, and, even in the case where there is friction torque depending on the rotation direction, the attachment position error of the rotational position sensor may be detected with high accuracy. Note that, in the embodiment, the example in which the phase of current for rotating the motor clockwise is output and then the phase of current for rotating the motor counter-clockwise is output has been explained, however, the phase of current for rotating the motor counter-clockwise may be output and then the phase of current for rotating the motor clockwise may be output. In this case, also the influence of the friction torque and the cogging torque may be cancelled.

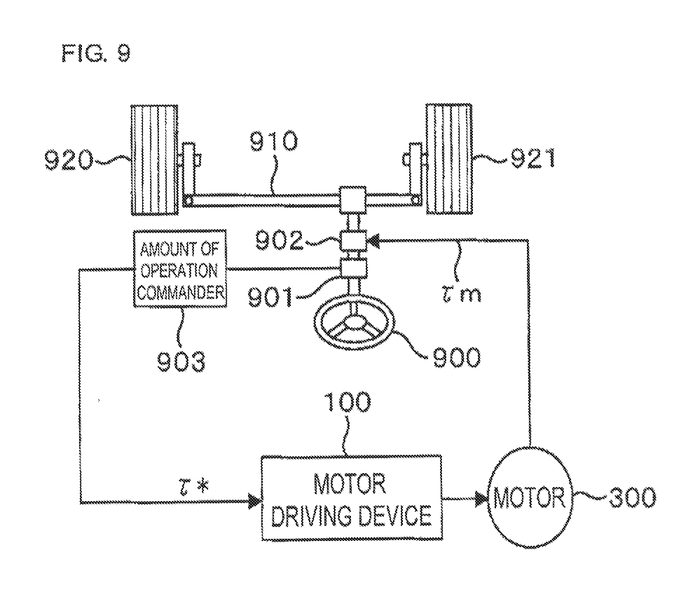

Next, a configuration of an electric power steering system to which the motor driving apparatus shown in the respective embodiments of the invention is applied will be explained using FIG. 9.

FIG. 9 is a configuration diagram of the electric power steering system to which the motor driving apparatus shown in the respective embodiments of the invention is applied.

An electrical actuator includes a torque transmission mechanism 902, the motor 300, and the motor driving apparatus 100 as shown in FIG. 9. The electric power steering system includes the electrical actuator, a steering wheel 900, a steerage angle detector 901, and an amount of operation commander 903, and has a configuration that torque-assists the operation force of the steering wheel 900 steered by a driver using the electrical actuator.

A torque command τ* of the electrical actuator is a steering assist torque command of the steering wheel 900 (created in the amount of operation commander 903) for reducing the steering force of the driver using the output of the electrical actuator. The motor driving apparatus 100 receives the torque command τ* as an input command and controls the motor current to follow the torque command value from the torque constant of the motor 300 and the torque command τ*.

The motor output τM output from the output shaft directly connected to the rotor of the motor 300 transmits torque to a rack 910 of the steering system via the torque transmission mechanism 902 using a deceleration mechanism including a worm wheel gear or planetary gear or a hydraulic mechanism, reduces (assists) the steering force (operation force) of the steering wheel 900 of the driver by an electric force and operates the steering angle of wheels 920, 921.

The amount of assist is determined by detecting the amount of operation as the steering angle and the steering torque by the steerage angle detector 901 for detection of the steering state incorporated in a steering shaft and adding or considering a quantity of state including the vehicle speed and road surface state as the torque command τ* by the amount of operation commander 903.

The motor driving apparatus 100 of the invention may correct the initial position shift regardless of the magnitude of the friction torque, and, as a result, has an advantage of correcting the amount of initial position shift after incorporated into a vehicle.

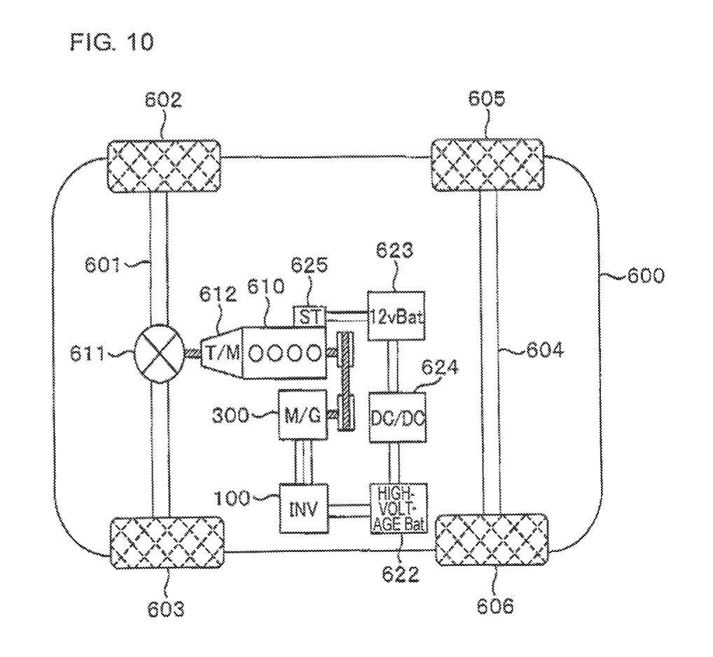

Next, another embodiment of a vehicle to which the motor driving apparatus according to the invention is applied will be explained using FIG. 10.

FIG. 10 is a configuration diagram of a hybrid automobile system to which the motor driving apparatus of the invention is applied.

The hybrid automobile system has a power train in which the motor 300 is applied as a motor/generator as shown in FIG. 10.

In an automobile shown in FIG. 10, the reference sign 600 denotes a vehicle body. A front wheel axle shaft 601 is rotatably supported in the front part of the vehicle body 600, and front wheels 602, 603 are provided at the ends of the front wheel axle shaft 601. A rear wheel axle shaft 604 is rotatably supported in the rear part of the vehicle body 600, and rear wheels 605, 606 are provided at the ends of the rear wheel axle shaft 604.

A differential gear 611 as a power distribution mechanism is provided in the center part of the front wheel axle shaft 601 to distribute the rotation driving force transmitted from an engine 610 via a transmission 612 to the front wheel axle shaft 601 on the right and the left. With respect to the engine 610 and a synchronous electric motor 620, a pulley 610a provided on a crank shaft of the engine 610 and a pulley 620a provided on the rotation shaft of the synchronous electric motor 620 are mechanically connected via a belt 630.

Thereby, the rotation driving force of the motor 300 may be transmitted to the engine 610 and the rotation driving force of the engine 610 may be transmitted to the motor 300. In the motor 300, the three-phase AC power controlled by the motor driving apparatus 100 is supplied to the stator coil of the stator, and thereby, the rotor rotates and generates a rotation driving force in response to the three-phase AC power.

That is, the motor 300 is controlled by the motor driving apparatus 100 to operate as an electric motor, and operates as a power generator that generates three-phase AC power because the rotor rotates by the rotation driving force of the engine 610 and an electromotive force is induced in the stator coil of the stator.

The motor driving apparatus 100 is a power converter that converts the DC power supplied from a high-voltage battery as a high-voltage (42 V or 300 V) power source into three-phase AC power, and controls the three-phase AC current flowing in the stator coil of the motor 300 in response to the magnetic pole positions of the rotor according to the operation command value.

The three-phase AC power generated by the motor 300 is converted into DC power by the motor driving apparatus 100 and charges the high-voltage battery 622. The high-voltage battery 622 is electrically connected to a low-voltage battery 623 via a DC-DC converter 624. The low-voltage battery 623 forms a low-voltage (14 V) power source of the automobile and is used as a power source for a starter 625 that initially starts the engine 610 (cold start), a radio, a light, etc.

When the vehicle stops for waiting for a traffic light (idle stop mode), for stopping the engine 610 and restarting the engine 610 at restart (hot start), the synchronous electric motor 620 is driven by the motor driving apparatus 100 and the engine 610 is restarted. Note that, in the idle stop mode, when the amount of charge of the high-voltage battery 622 is insufficient or the engine 610 is not sufficiently warmed, driving of the engine 610 is continued without stopping the engine 610. Further, in the idle stop mode, it is necessary to secure a drive source for electric auxiliary units with the engine 610 as a drive source such as a compressor of an air conditioner. In this case, the electric auxiliary units are driven by driving the synchronous electric motor 620.

Also, in an acceleration mode and a high-load operation mode, the motor 300 is driven to assist the driving of the engine 610. On the other hand, in the charge mode requiring charging of the high-voltage battery 622, the motor 300 is allowed to generate power by the engine 610 to charge the high-voltage battery 622. That is, the regeneration mode at braking and deceleration of the vehicle is performed.

In the motor driving apparatus for vehicle, when there are abnormalities in the motor and the transmission, overhaul and reassembly are desired in a service station. In the initial position adjustment unit 140 of the invention, there is an advantage that, even when the attachment position error of the rotational position sensor changes, the initial adjustment mode command is executed at service, and thereby, high-efficiency operation using the appropriate rotational position can be performed by detecting the attachment position error after maintenance repair at the service station and rewriting the rotor detection position error in the nonvolatile memory. Preferably, while the vehicle is set in the parking state and the transmission 612 is set to the neutral gear and the load of the motor is minimized, the attachment position error may be appropriately detected even in a state where the device has been incorporated into the vehicle.

In the above-described embodiments, the case where the motor driving apparatus 100 of the invention is applied to the hybrid automobile system has been explained, however, the same advantage may be obtained even in an electric car.

Further, in the above-described embodiments, the inverter device alone has been explained, however, obviously, the invention may be applied to a motor drive system in which the inverter device and the motor are integrated as long as the system has the above-described function.

Furthermore, the inverter device may include a control unit that increases the PWM duty so that the inverter DC current in the stop position of the rotor may take a predetermined current value, then holds the PWM duty, and outputs the PWM duty so that the applied voltage may take a predetermined value. Thereby, the magnitude of the current when the motor rotational position is designated by rotating the motor clockwise or counter-clockwise may be adjusted and the adjustment time may be shortened. The other features of the inverter device are the same as those of the description of the embodiments.

In addition, the inverter device may include a control unit that, at the phase of current for designating the motor rotational position by rotating the motor clockwise, increases the PWM duty so that the inverter DC current may take a predetermined current value and performs output with the PWM duty held and, at the phase of current for designating the motor rotational position by rotating the motor counter-clockwise, increases the PWM duty so that the inverter DC current may take a predetermined current value and performs output with the PWM duty held. The other features of the inverter device are the same as those of the description of the embodiments.

Note that the invention is not limited to the above-described embodiments, but various changes may be made without departing from the scope of the invention.

The disclosure of the following priority application is incorporated herein by reference.

Japanese Patent Application No. 2011-162765 (filed on Jul. 26, 2011).

1. An inverter device that controls a motor using a signal from a position sensor for detecting a rotor rotational position of the motor, comprising:
an initial adjustment unit that outputs a phase of current for designating a motor rotational position by rotating the motor in a clockwise direction of the motor and a phase of current for designating the motor rotational position by rotating the motor in a counter-clockwise direction of the motor.

2. The inverter device according to claim 1, wherein:
the initial adjustment unit outputs the phase of current for rotating the motor in the clockwise direction, and then, outputs the phase of current for rotating the motor in the counter-clockwise direction.

3. The inverter device according to claim 1, wherein:
the initial adjustment unit outputs the phase of current for rotating the motor in the counter-clockwise direction, and then, outputs the phase of current for rotating the motor in the clockwise direction.

4. The inverter device according to claim 1, wherein:
the initial adjustment unit sets a rotation angle for rotating the motor to 60 degrees in electric angle.

5. The inverter device according to claim 1, wherein:
the initial adjustment unit sets a vehicle in a parking state at inspection of the inverter device and outputs a command signal for initial operation.

6. An inverter device that performs motor control using a motor having a position sensor for detecting a rotational position of a rotor and a signal from the position sensor, comprising:
a control unit that increases a PWM duty so that an inverter DC current in a stop position of the rotor takes a predetermined current value and then holds the PWM duty, and outputs the PWM duty so that an applied voltage takes a predetermined value.

7. The inverter device according to claim 6, wherein:
the control unit sets a rotation angle for rotating the motor to 60 degrees in electric angle.

8. The inverter device according to claim 6, wherein:
the control unit sets a vehicle in a parking state at inspection of the inverter device and outputs a command signal for initial operation.

9. An inverter device that controls a motor using a signal from a position sensor of the motor having the position sensor for detecting a rotational position of a rotor, comprising:
an initial adjustment unit that outputs a phase of current for designating a motor rotational position by rotating the motor in a clockwise direction of the motor and a phase of current for designating the motor rotational position by rotating the motor in a counter-clockwise direction of the motor; and
a control unit that increases a PWM duty so that an inverter DC current takes a predetermined current value at a phase of current for designating the motor rotational position and then holds the PWM duty.
